(19) United States
(12) Patent Application Publication
(10) Pub. No.: US 2007/0162361 A1
(43) Pub. Date: Jul. 12, 2007

(54) Method and Data Processing System For Performing An Audit

(75) Inventors: Udo Kleemann, Stadecken-Elsheim (DE); Rainer Krause, Kostheim (DE); Markus Schmidt, Seibersbach (DE); Hartmut Seitter, Aidlingen (DE); Christian Waldenmaier, Pforzheim (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/566,710

(22) Filed: Dec. 5, 2006

(30) Foreign Application Priority Data
Jan. 9, 2006 (EP) 06108161.6

(51) Int. Cl. G07F 19/00; G07B 17/00

(52) U.S. Cl. 705/30

(57) ABSTRACT

A computerized method of evaluating a questionnaire comprising a set of questions of a category, wherein the method comprises the step of requesting a response for each question of the set of questions from an auditee, wherein each response is given in form of a quantitative value. The method further comprises the steps of determining an auditee specific statistics value from each quantitative value of each response given by the auditee and of requesting a response for each question of the set of questions from at least one auditor, wherein each response is given by the at least one auditor in form of the quantitative value, and wherein to each auditor an auditor weight factor is assigned which is specific for the auditor and for the category. For each auditor an auditor specific statistics value is determined from each quantitative value of each response given by the auditor.

### FIELD OF THE INVENTION

The invention relates to a method and a data processing system for performing an audit in general and to a method and a data processing system for evaluating an audit by taking into account the auditors and the auditees.

### BACKGROUND AND RELATED ART

An audit is generally carried out in order to evaluate an organization, system, process, technology or product. Moreover an audit is typically carried out in several stages. In a first stage, a questionnaire is prepared by a lead auditor. The questionnaire typically holds questions referring to one or more categories that relate to the organization, system, process, technology or product to be evaluated. The questionnaire is given by the lead auditor to an auditee, who is supposed to answer the questions of the questionnaire. The auditee is typically a person who has the competence to answer the questions with a very high degree of accuracy. In the next stage, the questionnaire is given back to the lead auditor which evaluates and assesses the organization, system, process or product based on the responses given by the auditee.

An audit is sometimes even made in a manual mode, which means that the questionnaire consists of a sheet of paper and that the responses given by the auditee are transferred into a computer system for further evaluation. Transcription errors from the paper form into the digital form are pre-assigned. Moreover the transcription is a very time consuming process which does however not contribute to an increase of productivity.

The evaluation of a questionnaire is made nowadays on a fairly subjective level, since the auditor is simply evaluating the responses given by the auditee according to his skills and knowledge.

There is therefore a need for an improved method and for an improved data processing system for evaluating a questionnaire.

### SUMMARY OF THE INVENTION

In accordance with an embodiment of the invention, there is provided a computerized method of evaluating a questionnaire comprising a set of questions of a category, wherein the method comprises the step of requesting a response for each question of the set of questions from an auditee, wherein each response is given in form of a quantitative value. The method further comprises the steps of determining an auditee specific statistics value from each quantitative value of each response given by the auditee and of requesting a response for each question of the set of questions from at least one auditor, wherein each response is given by the at least one auditor in form of the quantitative value, and wherein to each auditor an auditor weight factor is assigned to which is specific for the auditor and for the category. For each auditor an auditor specific statistics value is determined from each quantitative value of each response given by the auditor. A mean auditor statistics value is further determined from each auditor specific statistics value. For the determination of the mean auditor statistic value, each auditor specific statistics value is weighted according to the auditor weight factor. A category result is determined by a comparison of the mean auditor statistics value with the auditee specific statistics value. Each response given by the auditee and by each auditor, the auditee specific statistics value, the auditor specific statistics value of each auditor, the mean auditor statistics value and the category result are stored.

The questions of a category are posed to an auditee as well as to one or more auditors. The answers or responses given by the auditee and the auditors are either given directly in form of a quantitative value or they are transformed to a quantitative value if the answers are given for example by “yes” or “no”. By use of the quantitative values an auditor specific statistics value or an auditee specific statistics value can be determined. The category result can be used in order to evaluate the audit. If the mean auditor statistics value is larger than the auditee specific statistics value, then the auditee underestimates his capability, while otherwise he overestimates his capability. According to the category result, corrective actions can be taken into account. If the audit is for example carried out for evaluating a product and the category comprises questions referring to the quality of the product, then quality problems could be revealed by the audit. If the product is incorporated in another product then a possible corrective action would for example be an interruption of the supply chain until the quality problems of the product are resolved.

In accordance with an embodiment of the invention, the method further comprises the steps of comparing the mean auditor statistics value and the auditee specific statistics value with a clip level and of generating a message if the mean auditor statistics value and the auditee specific statistics value are smaller than the clip level and if the difference between the clip level and the mean auditor statistics value is larger than a given threshold value or if the difference between the clip level and the auditor specific statistics value is larger than the given threshold value, whereby the message is an alert message. The method in accordance with an embodiment of the invention is particularly advantageous as by the comparison of the auditee specific statistics value or the mean auditor statistics value with a clip level any problem of the for example process or system that is evaluated can be identified immediately. The alert message is used to immediately react to the problems that have been revealed by the evaluation of the questionnaire.

In accordance with an embodiment of the invention, the method further comprises the steps of determining an auditee specific standard deviation for the auditee specific statistics value and an auditor specific standard deviation for the mean auditor statistics value. The auditee specific standard deviation and the auditor specific standard deviation are stored and the message is generated if the auditee specific standard deviation is higher than a specific value or if the auditor specific standard deviation is higher than another specific value, whereby the message is an alert message. The method in accordance with an embodiment of the invention is particularly advantageous as by the comparison between auditee specific standard deviation and auditor specific standard deviation any problem in the process, system, technology or organization that is evaluated can be identified immediately. The alert message is then used to immediately react to the problems that have been revealed by the evaluation of the questionnaire.

In accordance with an embodiment of the invention, a set of questions is selected of a category from a database, wherein the database holds a superset of questions for the category. Moreover at least one auditor is selected from the database, wherein the database holds further an auditor list. The auditor list lists all auditors along with the corresponding auditor weight factors of the category. Each question of the set of questions is sent to the auditee and to the at least one auditor. Each response that is received from the auditee and from the at least one auditor is stored in the database. The questions that are posed to the auditee and to the auditor are taken from a superset of questions that is stored in the database. This reduces the time which is required for the preparation of an audit.

In accordance with an embodiment of the invention, the questionnaire comprises at least two categories, wherein a specific category weight factor is assigned to each of the at least two categories, wherein an auditee specific audit result is determined from the auditee specific statistics value of each of the at least two categories by taking into account the category weight factor of each category, wherein an auditor specific audit result is determined from the mean auditor statistics values of each of the at least two categories by taking into account the category weight factor of each category, and wherein an audit result is determined by comparing the auditee specific audit result with the auditor specific audit result.

In accordance with an embodiment of the invention, each quantitative value of each response given by the auditee is compared with each quantitative value of each response given by each auditor or with an average quantitative value, wherein the average quantitative value is determined by averaging over the quantitative values given by each auditor for a question and by taking into account the weight factor of each auditor.

In accordance with an embodiment of the invention, each response is either given by ‘yes’ or ‘no’, wherein a response given by ‘yes’ corresponds to a quantitative value of 1, and wherein a response given by ‘no’ corresponds to a quantitative value of 0.

In accordance with an embodiment of the invention, the weight factor assigned to an auditor for the category is determined by the average of the sum of an audit efficiency, an overall audit corrective action tracking value, an auditor specific audit count, and an auditor self assessed weight factor.

In accordance with an embodiment of the invention, a unique category identifier is assigned to each category, wherein a unique question identifier is assigned to each question, wherein a unique auditor identifier is assigned to each auditor, wherein a unique auditee identifier is assigned to each auditee, wherein the quantitative value of a response given by an auditor is stored in a database along with a unique category identifier, the unique question identifier and the unique auditor identifier, and wherein the quantitative value of a response given by an auditee is stored in a database along with the unique category identifier, the unique question identifier and the unique auditor identifier.

In the following, formulas are presented by which the quantities described above could be derived. It is assumed that the questionnaire comprises M categories, and that each category j comprises n questions. A question i of a category j is answered by an auditee by a quantitative value q_{i,j} and by an auditor k by p_{i,j,k}, whereby the auditor weight factor of the auditor k is w_{j,k} for the category j. A formula for the auditor weight factor is given below. The ranges of which the possible quantitative values q_{i,j} and p_{i,j,k} are selected have to be identical. Typically, the values q_{i,j} and p_{i,j,k} lie in the range between zero and one, inclusively.

An auditee specific statistics value sv_{auditee,j} for a category j can be defined by:

$${sv}_{auditee , j} = \frac{1}{n} ( {\sum }_{i = 1}^{n} {q}_{i} ) ,$$

while a mean auditor specific statistics value sv_{auditor,j} for the category j is determined by:

$${sv}_{auditor , j} = \frac{1}{N} {\sum }_{k = 1}^{N} \frac{{w}_{j , k}}{n} ( {\sum }_{i = 1}^{n} {p}_{i , k} ) ,$$

whereby N is the total number of auditors participating in the audit.

A category result crⱼ can for example be determined by:

crⱼ=sv_{auditee,j}−sv_{auditor,j}

The magnitude of crⱼ can be used as criteria for evaluating the category j of the questionnaire and corrective actions can be initiated in according with the magnitude of crⱼ.

The auditee specific statistics value sv_{auditee,j} as well as the mean auditor specific statistics value sv_{auditor,j} can also be checked against a clip level clⱼ, which is a predefined value per category. The clip level can for example be predefined by the lead auditor.

If the difference between clip level clⱼ and auditee specific statistics value sv_{auditee,j} or if the difference between clip level clⱼ and the mean auditor specific statistics value sv_{auditor,j} becomes too large, then corrective actions should be taken into account.

For the evaluation of the whole questionnaire comprising M categories, each category j is weighted by a category weighting cwⱼ. The category weighting could for example be set by the lead auditor.

The category weighting is normalized to a value between zero and one by the following procedure:

The sum cw of all category weights is determined by

$$cw = {\sum }_{j = 1}^{M} {cw}_{j} .$$

For each category weight a normalized category weight ncwⱼ is calculated

ncwⱼ=cwⱼ/cw.

An audit result can then be determined from the responses given by the auditee and by the auditors. An auditee specific audit result ar_{auditee} can for example be determined by

$${ar}_{auditee} = {\sum }_{j = 1}^{M} {ncw}_{j} \cdot {sv}_{auditee , j} .$$

An auditor specific audit result ar_{auditor} can then accordingly be calculated by

$${ar}_{auditor} = {\sum }_{j = 1}^{m} {ncw}_{j} \cdot {sv}_{auditor , j} .$$

A comparison of the auditee specific audit result ar_{auditee} and the auditor specific audit result ar_{auditor} yields the audit result ar=(ar_{auditor}−ar_{auditee})/ar_{auditee}. A value of ar>0 indicates that the auditee overestimates his capabilities and that corrective action have to be considered, while a negative value indicates that the auditee underestimates his capabilities.

Each response given by the auditee can furthermore be compared with the corresponding responses given by the auditors

Δp_{i,j}=q_{i,j}−v_{i,j}, wherein

the mean quantitative value v_{i,j} for question i in category j is determined by

$${v}_{i , j} = \frac{1}{N} {\sum }_{k = 1}^{N} {w}_{j , k} \cdot {p}_{i , j , k} .$$

If Δp_{i,j} is larger than a specific value which could be defined by the lead auditor, then corrective actions could be taken into account. Thus, the method in accordance with an embodiment of the invention could even be used in order to identify any problem within a category.

The auditor weight factor w_{j,k} is specific for the auditor j and the category k and is given by

w_{j,k}=(AE+ACA+ACOⱼ+a_{j,k})/4,

wherein AE is the audit efficiency, wherein ACA is the overall audit corrective actions tracking value, wherein ACOⱼ is the auditor specific audit count, and wherein a_{j,k} is the auditor self assessed weight factor.

The audit result ar can further be evaluated with respect to a previous audit result arₚ which is obtained from an audit performed previously on the same subject. The comparison of an audit result with a previous audit result can be used in order to determine the audit efficiency (AE) which is particularly useful when an audit is performed in order to control the quality of a process or a product since any quality problem can be revealed immediately. If ar−arₚ>0, then AA is taken to be equal to one (AA=1), while otherwise AA is taken to be zero (AA=0).

If a quality problem, for example of a process or a product, has been resolved due to the evaluation and the corresponding corrective actions, then a value of QP=1 is assigned for the evaluation of the subsequent audit, otherwise QP=0.

If a quality problem has not been resolved within a specific period of time due to the evaluation and the corresponding corrective actions, then a value of QT=0 is assigned for the evaluation of the subsequent audit, otherwise QT=1.

Furthermore, if the corrective actions launched in response to the results of the previous audit have improved the quality of the process or the product, then a value of CA=1 is defined while otherwise CA=0.

The audit efficiency (AE) is then defined by

$$AE = \frac{1}{4} ( AA + QP + QT + CA ) .$$

Furthermore, a value AC can be defined by evaluating if the corrective actions taken into account after a previous audit are closed on a set time target or if they are better (B) or worse (W) than a set time target. The table below defines details:

TABLE 1

| AC | 0.1 | 0.2 | 0.3 | 0.4 | 0.5 | >0.5 |
|---|---|---|---|---|---|---|
| W | 0.8 | 0.6 | 0.4 | 0.2 | 0.1 | 0 |
| B | 1.1 | 1.2 | 1.3 | 1.4 | 1.5 | 1.5 |

The overall audit corrective actions tracking value (ACA) is then determined by summing up all the values AC that have been determined by evaluating the corrective actions taken after each audit of a series of audits, whereby n is the total number of audits

$$ACA = {\sum }_{i = 1}^{n} A {C}_{i} .$$

An audit count ACO_{j,k} which is specific for an auditor j and a category k is defined by the number of audits num divided by x, whereby the number of audits num refers to the total number of audits that have already been performed by the auditor j and that comprised the category k.

The audit count ACO_{j,k} is weighted by a set limit x (for example x=10) per category, so that it is given by

$${ACO}_{j , k} = \frac{num}{10} .$$

In order to ensure that ACO_{j,k} is less than or equal to 1, only at most x audits are taken into account for the determination of ACO_{j,k}. An auditor specific audit count ACOⱼ for an auditor j is then given by

$${ACO}_{j} = \frac{1}{M} {\sum }_{k = 1}^{M} {ACO}_{j , k} ,$$

wherein M is the total number of categories comprised in the questionnaire.

The auditor self assessed weight factor a_{j,k} is a weight factor that is self assigned by each auditor j for a category k. The weight factor is typically a value between 0 and 1.

The values above can be used in order to derive an auditor weight factor which is specific for an auditor and for a category. The auditor weight factor w_{j,k} which is specific for the auditor j and the category k is then given by

w_{j,k}=(AE+ACA+ACOⱼ+a_{j,k})/4.

If the AE and the ACA are not determinable, for example because there have been no other audits performed before to which the audit could be compared to, then these values are taken to be equal to zero. In this case, the auditor weight factor w_{j,k} could alternatively be determined by dividing the sum given above by 2 instead of 4.

Another embodiment of the invention relates to a computer program product comprising computer executable instructions for performing a method in accordance with embodiments of the invention.

In another aspect an embodiment of the invention relates to a data processing system of evaluating a questionnaire comprising a set of questions of a category, wherein the data processing system comprises means for requesting a response for each question of the set of questions from an auditee, wherein each response is given in form of a quantitative value. The data processing system further comprises means for determining an auditee specific statistics value for each quantitative value of each response given by the auditee and means for requesting a response for each question of the set of questions from at least one auditor, wherein each response is given in form of a quantitative value, and wherein each auditor having assigned an auditor weight factor, wherein the auditor weight factor being specific for each auditor and for the category.

The data processing system further comprises means for determining for each auditor an auditor specific statistics value from each quantitative value of each response given by the auditor and means for determining a mean auditor statistics value from each auditor specific statistics value. Each auditor specific statistics value is weighted according to the auditor weight factor assigned to the auditor. The method in accordance with an embodiment of the invention further comprises means for determining a category result by a comparison between the mean auditor statistics value with the auditor specific statistics value and means for storing each response given by the auditee and by each auditor, the auditee specific statistics value, the auditor specific statistics value of each auditor, the mean auditor statistics value, and the category result.

### BRIEF DESCRIPTION OF THE DRAWINGS

In the following, preferred embodiments of the invention will be described in greater detail by way of example only making reference to the drawings in which:

FIG. 1 shows a block diagram of a computer system for auditing an auditee and an auditor,

FIG. 2 shows a flow diagram illustrating the basic steps for performing the method in accordance with an embodiment of the invention,

FIG. 3 shows a block diagram of an auditing system,

FIG. 4 shows a flow diagram illustrating the major steps performed by the method in accordance with an embodiment of the invention.

### DETAILED DESCRIPTION

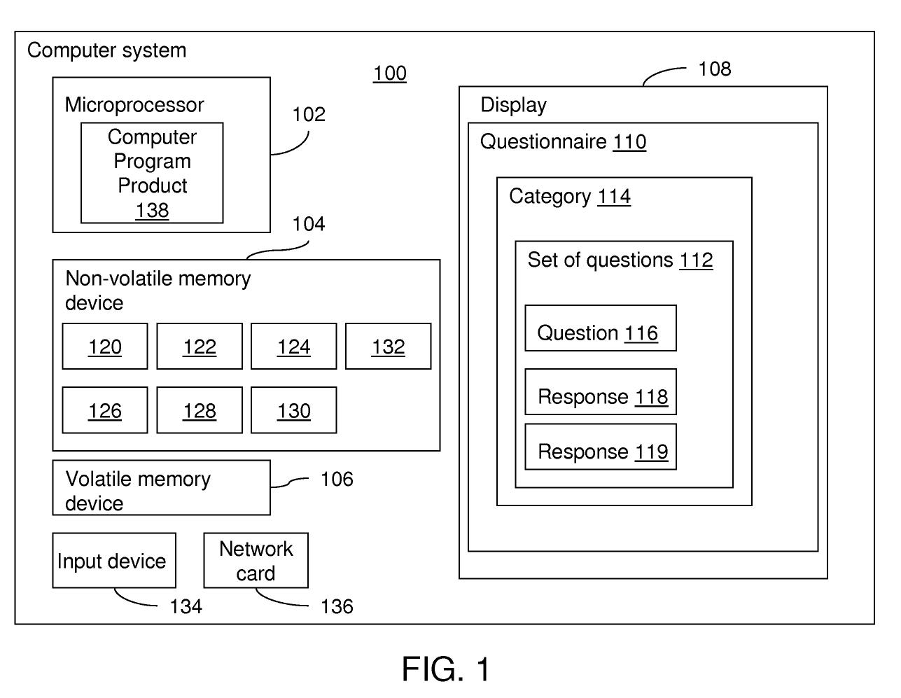

FIG. 1 shows a computer system 100 which comprises a microprocessor 102, a non-volatile memory device 104, a volatile memory device 106, a display 108, an input device 134, and a network card 136.

The display 108 shows a questionnaire 110, which comprises a set of questions 112 referring to category 114. The microprocessor 102 executes a computer program product 138 which comprises instructions for performing the method in accordance with an embodiment of the invention.

The questions of the set of questions 112 are answered by an auditee and by at least one auditor. The auditee and the at least one auditor typically work on different computer systems. For the following it is however assumed for reasons of compactness that the auditee and one auditor respond to the questionnaire 110 and that both work on computer system 100. More complex scenarios, taking into account several auditors that work on different computer systems are described further below.

The responses of the auditee and the auditor are either given by ‘yes’ or ‘no’ or by a quantitative value. If the answer is given by ‘yes’, then a quantitative value of 1 is assigned to the response. If the question is answered by ‘no’, then the quantitative value corresponding to the answer is taken to be 0. The questions that are directly answered by a quantitative value are typically answered by values between 0 and 1, inclusively. The auditee answers for example to question 116 by response 118, which either directly corresponds to the quantitative value 120 or which is transformed to either 0 or 1 and then assigned to the quantitative value 120, if the response 118 is given by ‘yes’ or ‘no’. The response is typically given by typing the quantitative value into the computer system 100 by use of the input device 134, which is in this case a keyboard. From the quantitative values of each response given by the auditee, an auditee specific statistics value 122 is determined.

The auditor also answers the questions of the set of questions 112. The auditor gives for example the response 119 with respect to question 116. The response 119 is either given directly in form of a quantitative value 124 or is translated to a quantitative value if the question is given by either ‘yes’ or ‘no’. If the response 119 is given by ‘yes’ or ‘no’, then the quantitative value 124 is taken to be either 0 or 1. From the quantitative values of each response given by the auditor, an auditor specific statistics value 128 is determined. If there is only one auditor, then the auditor specific statistics value 128 corresponds to the mean auditor statistics value 130.

An auditor weight factor 126 is assigned to each auditor. If there is only one auditor as described above, then the auditor weight factor 126 does not have to be taken into account. If more auditors participate in the audit, then the auditor weight factors of the auditors are used for the determination of the mean auditor statistics value 130.

The category result 132 is determined by a comparison between the mean auditor statistics value 130 and the auditee specific statistics value 122. Formulas which could be employed in order to derive the various parameters are given at the end of this section.

The quantitative values of each response, such as quantitative values 120 and 124 referring to responses 118 and 119 are stored along with the auditee specific statistics value 122, the auditor specific statistics values of each auditor, the mean auditor statistics values 130, and the category result 132 on the non-volatile memory device 104 or alternatively on the volatile memory device 106.

The network card 136 is used to transfer all data obtained from the audit to a centralized database for further evaluation.

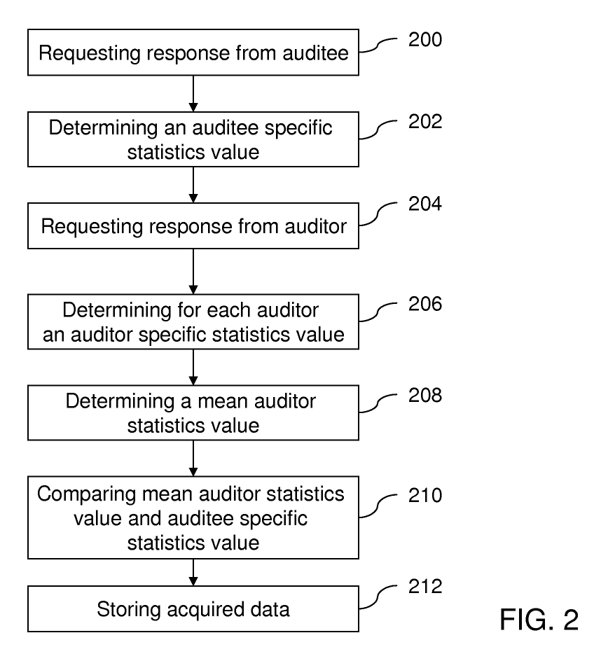

FIG. 2 shows a flow diagram illustrating the basic steps for performing the method in accordance with an embodiment of the invention. In step 200 responses are requested from an auditee for a set of questions of a category. In step 202 an auditee specific statistics value is determined from the responses of the auditors, whereby the responses are given by quantitative values. In step 204 responses are requested from an auditor for the same set of questions that have been given to the auditee. For the responses of each auditor, which are given in form of quantitative values, an auditor specific statistics value is determined in step 206. A mean auditor statistics value is determined in step 208 from the auditor specific statistics values of each auditor. In step 210 the mean auditor statistics value and the auditor specific statistics value are compared and in step 212 the various values that have been obtained by requesting responses from the auditee and from the at least one auditor are stored.

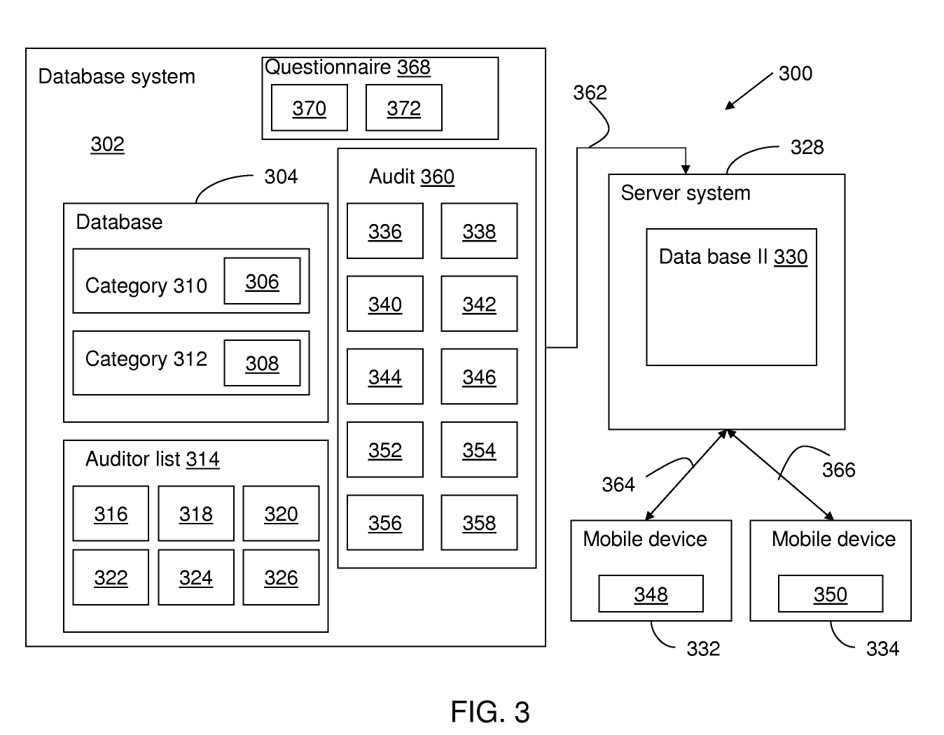

FIG. 3 shows a block diagram of an audit system 300. The audit system 300 consists of a database system 302, a server system 328, and several mobile devices such as mobile device 332 and mobile device 334. The mobile devices 332 and 334 are for example laptops, PDAs (Personal Digital Assistants), or cell phones.

The database system 302 is connected to the server system 328 via a network connection 362, which could for example be a LAN or a WAN connection. The mobile devices 332 and 334 are connected by the network connections 364 and 366 to the server system 328. The network connections 364 and 366 can be any kind of network connections appropriate for connecting a mobile device to a server system such as a LAN (local area network) connection, a WAN (wide area network) connection, or a Bluetooth (IEEE 802.15.1) connection.

The connections 362, 364 and 366 can also be connections that are provided via the internet. Thus the database 302 could be placed for example in Europe, the server system 328 could be situated in North America, while the mobile devices 332 or 334 are used somewhere in South America or in Asia. The database system 302, the server system 328 and the mobile devices 332 and 334 can therefore be distributed around the world.

The database system 302 comprises a database 304 that hold questions that are assigned to various categories. For example category 310 holds a superset of questions 306 and category 312 holds a superset of questions 308. If an audit is scheduled, a lead auditor selects a set of questions out of the questions held in database 304 in order to design a questionnaire 368 that meets his requirements. For example, he selects a set of questions 370 from the superset of questions 306 of category 310 and a set of questions 372 from the superset of questions 308 of category 312. Questions comprised in the various categories are usually determined by experts. In order to ensure a high quality audit, each question that is held in the database has been reviewed and approved by a committee.

The database system 302 further holds an auditor list 314. Each auditor which is eligible to participate in an audit is listed there. For example, auditor list 314 lists auditor A 316, and auditor B 322. An auditor weight factor is assigned to each auditor for each category. For example, auditor weight factor 318 is assigned to auditor A 316 for responses given to questions of category 310, and auditor weight factor 320 is assigned to auditor A 316 relating to category 312. Similarly, auditor weight factor 324 relates to category 310, and auditor weight factor 326 relates to category 312, whereby both auditor weight factors are assigned to auditor B 322.

As mentioned before the lead auditor selects questions from various categories. The average auditor weight factors of the selected categories can be determined for each auditor. A given number of auditors could be proposed to the lead auditor. These auditors are the auditors with the highest average auditor weight factors. The given number can for example be set by the lead auditor.

The questionnaire 368 is then transmitted to the server system 328 and stored in the database II 330. From there it is further transmitted to the mobile devices 332 and 334. Auditor 348 works on mobile device 332 and answers the questions of a set of questions 370 and 372 while auditee 350 answers the same questions on mobile device 334. The auditor 348 is one of the auditors that have been chosen by the lead auditor, for example auditor 348 corresponds to auditor A 316 listed in the auditor list 314.

The questionnaire is sent back via the server system 328, where a copy is stored in database II 330, to the database system 302. The complete audit 360 (questionnaire 368 plus given responses) is stored on the database system 302. In order to use the available storage space on the database 302 more efficiently the audit 360 is stored in the following way: each category is characterized by a category identifier, each question is characterized by a question identifier, each auditor, and each auditee are characterized by an auditor or an auditee identifier, respectively. For example category 310 is identifiable by category identifier 336 and category 312 is identifiable by category identifier 338. The question of category 310 is characterized by question identifier 340 and a specific question of category 312 is characterized by question identifier 342. Furthermore auditor A 316 is identifiable through auditor identifier 344 and auditor B 322 is characterized through auditor identifier 346. Two auditees are characterized by auditee identifier 352 and 354. A response 358 given to a specific question by an auditor A 316 is for example stored by the category of the question, the question identifier, the auditor identifier of auditor A, and the quantitative value 356 corresponding to response 358.

The database system 302 therefore comprises questions that are eligible for an audit, and an auditor list. The database system 302 further holds all results which are obtained from an audit. The database system 302 is therefore the single point of truth regarding all data used for and obtained from an audit. The algorithm used to evaluate the audit parametric uses the data in database system 302 to generate reports and to perform analysis of an audit that has been performed. The data is exchanged via replication mechanisms for example to server system 322. The server system 322 will get the data relevant for an audit. Thus they will for example get the questionnaire 368 for performing an audit. After receiving the audit the server can work in disconnected mode and can distribute the questionnaire to the mobile devices 332 and 334 independent from the database system 302. The questionnaire will also be held in the database II 330 so that changes can be made during an audit or during an audit assessment. The mobile devices 332, 334 can also be equipped with a voice recording system, or a touch screen. The mobile devices 332 and 334 will be used to record the questionnaire 368 plus the given responses by the auditees or by the auditors from which the data is then sent back to the server system 328.

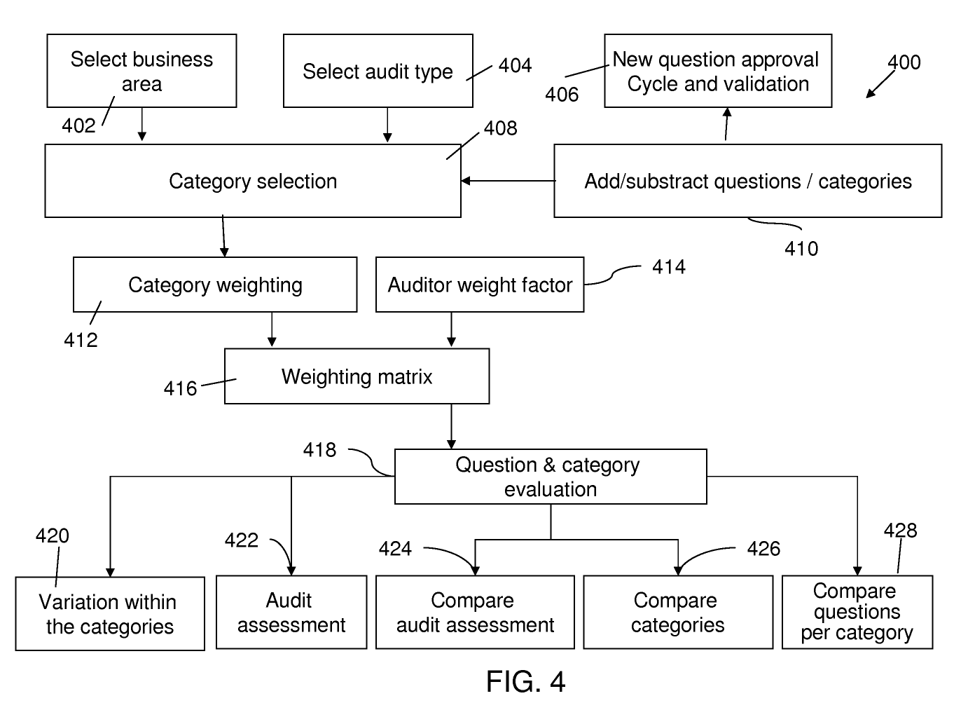

FIG. 4 shows a flow diagram 400 illustrating the major steps performed by the method in accordance with an embodiment of the invention. In step 402, the business area for which an audit is supposed to be carried out is determined. The business area specifies if the audit relates to an enterprise, an organization, a process, a product or a technology. In step 404 an audit type is determined. The audit type specifies if the audit relates for example to a quality control audit which is performed for a process or a product or if the audit relates for example to an evaluation of a product with respect to a competitive product. Based on the selection of a business area and on the selection of an audit type, the categories to be audited are chosen in step 408. As mentioned before, each category comprises a set of questions which are stored in a database. Categories and questions could be added to or deleted from the database as indicated in step 410. However as remarked in step 406 a new question as well as a new category that is considered to be inserted into the database undergoes an approval and validation cycle by a quality control committee.

In step 412, each category comprised in an audit is weighted by a category weighting factor. The category weighting factors can for example be determined by the lead auditor. In step 416 a weighting matrix is determined through which the responses given by the auditor and the auditees can be evaluated. The weighting matrix is a generic expression for the formulas given above in order to evaluate the responses given be the auditors and the auditees with respect to the category result, the audit result and so one. The notion weighting matrix is used because the audit result could be derived directly from the responses when the corresponding formulas given above are written in a compact matrix form. Auditor weight factors w_{j,k} which are auditor and category specific are taken into account as indicated by step 414 within the weighting matrix. A formula for the auditor weight factors w_{i,j} is given above.

In step 418, the responses given by the auditors and by the auditee are evaluated by taking into account the weighting matrix determined in step 416. In step 420 variations between the responses given by the auditors and by the auditees are determined per category. In step 422, the audit is assessed taking into account all categories separately for each auditor and for the auditee. In step 424, the audit assessments of the auditors and the auditee are compared. Furthermore, the responses given per category are compared in step 426. In step 428, the answers of each question are compared.

### LIST OF REFERENCE NUMERALS

| | |
|---|---|
| 100 | Computer system |
| 102 | Microprocessor |
| 104 | Non-volatile memory |
| | device |
| 106 | Volatile memory device |
| 108 | Display |
| 110 | Questionnaire |
| 112 | Set of questions |
| 114 | Category |
| 116 | Question |
| 118 | Response |
| 119 | Response |
| 120 | Quantitative value |
| 122 | Auditee specific |
| | statistics value |
| 124 | Quantitative value |
| 126 | Auditor weight factors |
| 128 | Auditor specific |
| | statistics value |
| 130 | Mean auditor statistics |
| | value |
| 132 | Category result |
| 134 | Input device |
| 136 | Network |
| 138 | Computer program product |
| 300 | Audit system |
| 302 | Database system |
| 304 | Database |
| 306 | Superset of questions |
| 308 | Superset of questions |
| 310 | Category |
| 312 | Category |
| 314 | Auditor list |
| 316 | Auditor A |
| 318 | Auditor weight factor |
| 320 | Auditor weight factor |
| 322 | Auditor B |
| 324 | Auditor weight factor |
| 326 | Auditor weight factor |
| 328 | Server system |
| 330 | Database II |
| 332 | Mobile device |
| 334 | Mobile device |
| 336 | Category identifier |
| 338 | Category identifier |
| 340 | Question identifier |
| 342 | Question identifier |
| 344 | Auditor identifier |
| 346 | Auditor identifier |
| 348 | Auditor |
| 350 | Auditee |
| 352 | Auditee identifier |
| 354 | Auditee identifier |
| 356 | Quantitative value |
| 358 | Response |
| 360 | Audit |
| 362 | Network connection |
| 364 | Network connection |
| 366 | Network connection |
| 368 | Questionnaire |
| 370 | Set of questions |
| 372 | Set of questions |

1. A computerized method of evaluating a questionnaire comprising a set of questions of a category, said computerized method comprising:
requesting a response for each question of said set of questions from an auditee, wherein each response is given in form of a quantitative value;
determining an auditee specific statistics value from each quantitative value of each response given by said auditee;
requesting a response for each question of said set of questions from at least one auditor, wherein each response is given in form of a quantitative value, and wherein each auditor having assigned an auditor weight factor, said auditor weight factor being specific for each auditor and for said category;
determining for each auditor an auditor specific statistics value from each quantitative value of each response given by the auditor;
determining a mean auditor statistics value from each auditor specific statistics value, wherein each auditor specific statistics value is weighted according to said auditor weight factor assigned to said auditor;
determining a category result by a comparison of said mean auditor statistics value with said auditee specific statistics value; and
storing each response given by said auditee and by each auditor, said auditee specific statistics value, said auditor specific statistics value of each auditor, said mean auditor statistics value, and said category result.

2. The computerized method according to claim 1, said computerized method further comprising:
comparing said mean auditor statistics value and said auditee specific statistics value with a clip level; and
generating a message if said mean auditor statistics value and said auditee specific statistics value are smaller than said clip level and if the difference between the clip level and said mean auditor statistics value is larger than a given value or if the difference between the clip level and said auditee specific statistics value is larger than the given value, whereby said message is an alert message.

3. The computerized method according to claim 1, said computerized method further comprising:
determining an auditee specific standard deviation for said auditee specific statistics value and an auditor specific standard deviation for said mean auditor statistics value;
storing said auditee specific standard deviation and said auditor specific standard deviation; and
generating a message if said auditee specific standard deviation is higher than a specific value or if said auditee specific standard deviation is higher than another specific value, whereby said message is an alert message.

4. The computerized method according to claim 1, said computerized method further comprising:
selecting said set of questions of said category from a database, said database holding a superset of questions for said category;
selecting the at least one auditor from said database, said database holding further an auditor list, said auditor list listing all auditors along with the corresponding auditor weight factors of said category;
sending each question of said set of questions to said auditee and to the at least one auditor; and
receiving each response from said auditee and from said at least one auditor.

5. The computerized method according to claim 1, wherein said questionnaire comprises at least two categories, wherein to each of the at least two categories a specific category weight factor is assigned to, wherein an auditee specific audit result is determined from the auditee specific statistics values of each of the at least two categories, wherein an auditor specific audit result is determined from the mean auditor statistics values of each of the at least two categories, wherein an audit result is determined by comparing said auditee specific audit result with said auditor specific audit result, and whereby the specific category weight factors are taken into account for the determination of the auditor specific audit result and the auditee specific audit result.

6. The computerized method according to claim 1, wherein each quantitative value of each response given by said auditee is compared with each quantitative value of each response given by each auditor or with an average value, wherein said average value is determined by averaging over the quantitative values given by each auditor for a question and by taking into account the auditor weight factor of each auditor.

7. The computerized method according to claim 1, wherein each response is either given by yes or no, wherein a response given by yes corresponds to a quantitative value of one, and wherein a response given by no corresponds to a quantitative value of zero.

8. The computerized method according to claim 1, wherein the auditor weight factor assigned to an auditor for said category is determined by the average of the sum of an audit efficiency, an overall audit corrective action tracking value, an auditor specific audit count, and an auditor self assessed weight factor.

9. The computerized method according to claim 1, wherein a unique category identifier is assigned to each category, wherein a unique question identifier is assigned to each question, wherein a unique auditor identifier is assigned to each auditor, wherein a unique auditee identifier is assigned to each auditee, wherein the quantitative value of a response given by an auditor is stored in a database along with the unique category identifier, the unique question identifier and the unique auditor identifier, and wherein the quantitative value of a response given by an auditee is stored in a database along with the unique category identifier, the unique question identifier and the unique auditee identifier.

10. A computer program product comprising computer executable instructions for causing a computer to perform a method of evaluating a questionnaire which comprises a set of questions of a category, the method comprising the steps of:
requesting a response for each question of said set of questions from an auditee, wherein each response is given in form of a quantitative value;
determining an auditee specific statistics value from each quantitative value of each response given by said auditee;
requesting a response for each question of said set of questions from at least one auditor, wherein each response is given in form of a quantitative value, and wherein each auditor having assigned an auditor weight factor, said auditor weight factor being specific for each auditor and for said category;
determining for each auditor an auditor specific statistics value from each quantitative value of each response given by the auditor;
determining a mean auditor statistics value from each auditor specific statistics value, wherein each auditor specific statistics value is weighted according to said auditor weight factor assigned to said auditor;
determining a category result by a comparison of said mean auditor statistics value with said auditee specific statistics value; and
storing each response given by said auditee and by each auditor, said auditee specific statistics value, said auditor specific statistics value of each auditor, said mean auditor statistics value, and said category result.

11. A data processing system for evaluating a questionnaire comprising a set of questions of a category, said data processing system comprising:
means for requesting a response for each question of said set of questions from an auditee, wherein each response is given in form of a quantitative value;
means for determining an auditee specific statistics value from each quantitative value of each response given by said auditee;
means for requesting a response for each question of said set of questions from at least one auditor, wherein each response is given in form of a quantitative value, and wherein each auditor having assigned an auditor weight factor, said auditor weight factor being specific for each auditor and for said category;
means for determining for each auditor an auditor specific statistics value from each quantitative value of each response given by the auditor;
means for determining a mean auditor statistics value from each auditor specific statistics value, wherein each auditor specific statistics value is weighted according to said auditor weight factor assigned to said auditor;
means for determining a category result by a comparison of said mean auditor statistics value with said auditee specific statistics value; and
means for storing each response given by said auditee and by each auditor, said auditee specific statistics value, said auditor specific statistics value of each auditor, said mean auditor statistics value, and said category result.

12. The data processing system according to claim 11, said data processing system further comprising:
means for comparing said mean auditor statistics value and said auditee specific statistics value with a clip level; and
means for generating a message if said mean auditor statistics value and said auditee specific statistics value are smaller than said clip level and if the difference between the clip level and said mean auditor statistics value is larger than a given value or if the difference between the clip level and said auditee specific statistics value is larger than the given value, whereby said message is an alert message.

13. The data processing system according to claim 11, said data processing system further comprising:
means for determining an auditee specific standard deviation for said auditee specific statistics value and an auditor specific standard deviation for said mean auditor statistics value;
means for storing said auditee specific standard deviation and said auditor specific standard deviation; and
means for generating a message if said auditee specific standard deviation is higher than a specific value or if said auditee specific standard deviation is higher than another specific value, whereby said message is an alert message.

14. The data processing system according to claim 11, said data processing system further comprising:
means for selecting said set of questions of said category from a database, said database holding a superset of questions for said category;
means for selecting the at least one auditor from said database, said database holding further an auditor list, said auditor list listing all auditors along with the corresponding auditor weight factors of said category;
means for sending each question of said set of questions to said auditee and to the at least one auditor; and
means for receiving each response from said auditee and from said at least one auditor.

15. The data processing system according to claim 11, wherein said questionnaire comprises at least two categories, and wherein to each of the at least two categories a specific category weight factor is assigned to, wherein an auditee specific audit result is determined from the auditee specific statistics values of each of the at least two categories, wherein an auditor specific audit result is determined from the mean auditor statistics values of each of the at least two categories, and wherein an audit result is determined by comparing said auditee specific audit result with said auditor specific audit result, and whereby the specific category weight factors are taken into account for the determination of the auditor specific audit result and the auditee specific audit result.

16. The data processing system according to claim 11, wherein each quantitative value of each response given by said auditee is compared with each quantitative value of each response given by each auditor or with an average value, wherein said average value is determined by averaging over the quantitative values given by each auditor for a question and by taking into account the auditor weight factor of each auditor.

17. The data processing system according to claim 11, wherein each response is either given by yes or no, wherein a response given by yes corresponds to a quantitative value of one, and wherein a response given by no corresponds to a quantitative value of zero.

18. The data processing system according to claim 11, wherein the auditor weight factor assigned to an auditor for said category is determined by the average of the sum of an audit efficiency, an overall audit corrective action tracking value, an auditor specific audit count, and an auditor self assessed weight factor.

19. The data processing system according to claim 11, wherein a unique category identifier is assigned to each category, wherein a unique question identifier is assigned to each question, wherein a unique auditor identifier is assigned to each auditor, wherein a unique auditee identifier is assigned to each auditee, wherein the quantitative value of a response given by an auditor is stored in a database along with the unique category identifier, the unique question identifier and the unique auditor identifier, and wherein the quantitative value of a response given by an auditee is stored in a database along with the unique category identifier, the unique question identifier and the unique auditee identifier.

20. The computer program product according to claim 10, further comprising computer executable instructions for causing a computer to perform the steps of:
comparing said mean auditor statistics value and said auditee specific statistics value with a clip level; and
generating a message if said mean auditor statistics value and said auditee specific statistics value are smaller than said clip level and if the difference between the clip level and said mean auditor statistics value is larger than a given value or if the difference between the clip level and said auditee specific statistics value is larger than the given value, whereby said message is an alert message.
